(19) United States
(12) Patent Application Publication
(10) Pub. No.: US 2014/0188937 A1
(43) Pub. Date: Jul. 3, 2014

(54) SYSTEMS, METHODS, AND MEDIA FOR CONTROLLING ACCESS TO MEDIA CONTENT

(71) Applicant: Sonic IP, Inc., Santa Clara, CA (US)

(72) Inventors: Michael G. Kiefer, Lake Havasu City, AZ (US); Kourosh Soroushian, San Diego, CA (US)

(73) Assignee: Sonic IP, Inc., Santa Clara, CA (US)

(21) Appl. No.: 13/729,891

(22) Filed: Dec. 28, 2012

(51) Int. Cl. G06F 17/30

(52) U.S. Cl. CPC G06F 17/30017
USPC 707/781

(57) ABSTRACT

Systems, methods and media for controlling access to media content are provided. In some embodiments systems for controlling access to media content are provided, the systems comprising processing circuitry configured to: determine whether media content can be0 associated with a slot; associate the media content with the slot and resetting a counter for the slot when it is determined that the media content can be associated with the slot; determine whether the media content is associated with the slot; grant access to the media content and updating a count of accesses to the media content when it is determined that media content is associated with the slot; determine if access to the media content has expired; and prevent access to the media content when it is determined that the access to the media content has expired.

### BACKGROUND OF THE INVENTION

Consumers of media content, such as movies, television programs, and short videos, are increasingly accessing media content from a variety of sources and are demanding that the media content be available to them whenever they like. For example, today's airplane passengers are widely watching media content on personally owned portable devices.

To enable media content to be accessible while away from a computer network, like when on an airplane, a consumer's media display device needs to have the ability to receive and store media content prior to being away from the computer network. For example, an airplane passenger may download media content to his or her device prior to leaving home.

In order to control distribution and use of such media, mechanisms for controlling access to the media content are provided in many portable devices. Unfortunately, however, prior mechanisms for controlling access to media content have been inadequate.

Accordingly, systems, methods, and media for controlling access to media content are provided.

### SUMMARY OF THE INVENTION

In view of the foregoing, systems, methods, and media for controlling access to media content are provided.

In particular, in some embodiments, systems for controlling access to media content are provided. In some embodiments, the systems comprise processing circuitry that is configured to: determine whether media content can be associated with a slot; associate the media content with the slot and resetting a counter for the slot when it is determined that the media content can be associated with the slot; determine whether the media content is associated with the slot; grant access to the media content and updating a count of accesses to the media content when it is determined that media content is associated with the slot; determine if access to the media content has expired; and prevent access to the media content when it is determined that the access to the media content has expired.

In some embodiments, methods for controlling access to media content are provided, the methods comprising: determining whether media content can be associated with a slot; associating, by a processing circuitry, the media content with the slot and resetting a counter for the slot when it is determined that the media content can be associated with the slot; determining whether the media content is associated with the slot; granting access to the media content and updating a count of accesses to the media content when it is determined that media content is associated with the slot; determining if access to the media content has expired; and preventing access to the media content when it is determined that the access to the media content has expired.

In some embodiments, non-transitory computer-readable media are provided. The non-transitory computer-readable media contain computer-executable instructions that, when executed by a processing circuitry, cause the processing circuitry to perform a method for controlling access to media content, the method comprising: determining whether media content can be associated with a slot; associating the media content with the slot and resetting a counter for the slot when it is determined that the media content can be associated with the slot; determining whether the media content is associated with the slot; granting access to the media content and updating a count of accesses to the media content when it is determined that media content is associated with the slot; determining if access to the media content has expired; and preventing access to the media content when it is determined that the access to the media content has expired.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1A and 1B show an example of an interactive media guidance application display that can be used with a process for selecting media content for presentation in accordance with some embodiments of the invention;

FIG. 2 shows an example of a block diagram of hardware that can be used in accordance with some embodiments of the invention;

FIG. 3 shows an example of a block diagram of user equipment device hardware that can be used in accordance with some embodiments of the invention;

FIG. 4 shows an example of a graphical illustration of a first architecture for controlling access to media content in accordance with some embodiments of the invention;

FIG. 5 shows an example of a graphical illustration of a second architecture for controlling access to media content in accordance with some embodiments of the invention; and

FIG. 6 shows an example of a flow diagram of a process for controlling access to media content in accordance with some embodiments of the invention.

FIGS. 7A and 7B are examples of data structures that can be used in accordance with some embodiments.

FIG. 8 is an example of a process for controlling access to media content that can be used in accordance with some embodiments.

### DETAILED DESCRIPTION OF EMBODIMENTS

This invention generally relates to systems, methods, and media for controlling access to media content. More particularly, in some embodiments, systems, methods, and media for controlling access to media content by associating the media, content with one or more groups and/or sets of media content, are provided, wherein one or more of the groups and/or sets of media content have any suitable presentation characteristics.

For example, in some embodiments, a user of media content may select to create a list of pieces of media content to be presented to the user in the future. For example, this list may include any suitable media content such as movies, television shows, audio recordings, etc. These pieces of media content can be available from any suitable sources, such as subscription movie providers, from rental providers, from over-the-air providers, from cable providers, etc., in some embodiments. Each piece of media content can be associated with a group and/or set of one or more pieces of media content (which group and/or set can be referred to herein as a “slot”), in some embodiments. One or more slots can be associated with a set of one or more slots, in some embodiments. These slots and/or sets can have any suitable characteristics regarding how the associated media content can be presented in some embodiments. For example, a piece of media content associated with a certain slot and/or a certain set can be limited to being presentable only during a certain time period, only for a certain number of presentations, only when the piece of media content is one of a limited number of pieces of media content, etc.

As referred to herein, the term “media content” should be understood to mean one or more electronically consumable media assets, such as television programs, pay-per-view programs, on-demand programs (e.g., as provided in video-on-demand (VOD) systems), Internet content (e.g., streaming content, downloadable content, Webcasts, etc.), movies, films, video clips, audio, audio books, and/or any other media or multimedia and/or combination of the same. As referred to herein, the term “multimedia” should be understood to mean media content that utilizes at least two different content forms described above, for example, text, audio, images, video, or interactivity content forms. Media content may be recorded, played, displayed or accessed by user equipment devices, but can also be part of a live performance. In some embodiment, media content can include over-the-top (OTT) content. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC.

Media content can be provided from any suitable source in some embodiments. In some embodiments, media content can be electronically delivered to a user's location from a remote location. For example, media content, such as a Video-On-Demand movie, can be delivered to a user's home from a cable system server. As another example, media content, such as a television program, can be delivered to a user's home from a streaming media provider over the Internet.

Media content to be presented can be selected in any suitable manner in some embodiments. For example, in some embodiments, media content can be selected by a user selecting the media content for presentation from an interactive media guidance application (which can also be referred to herein as a media guidance application or a guidance application).

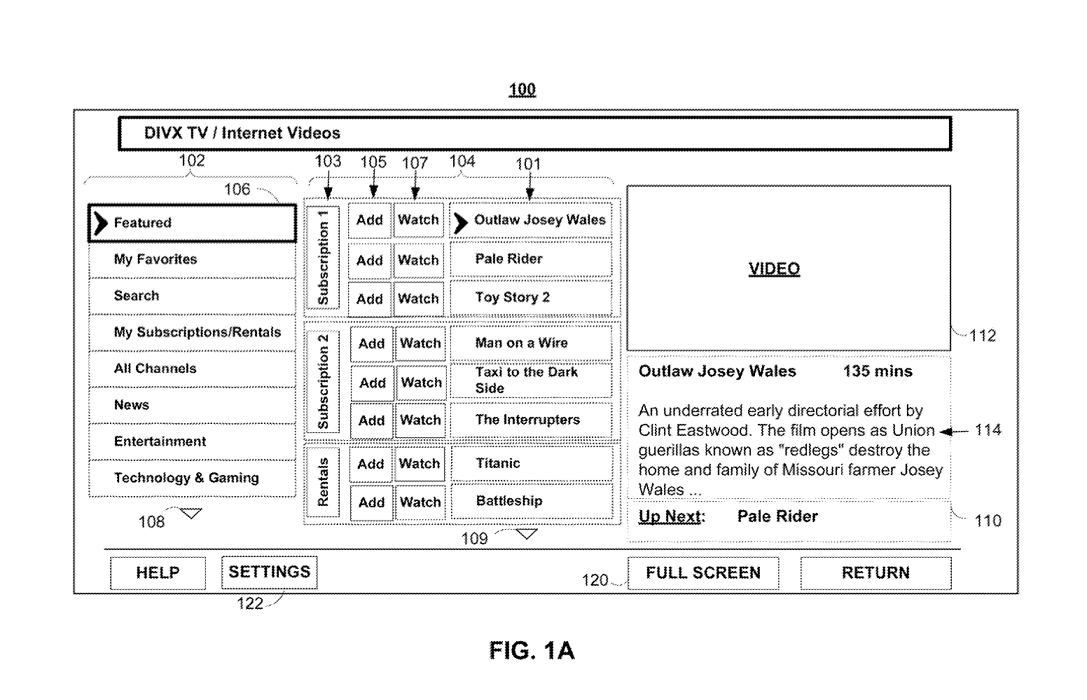

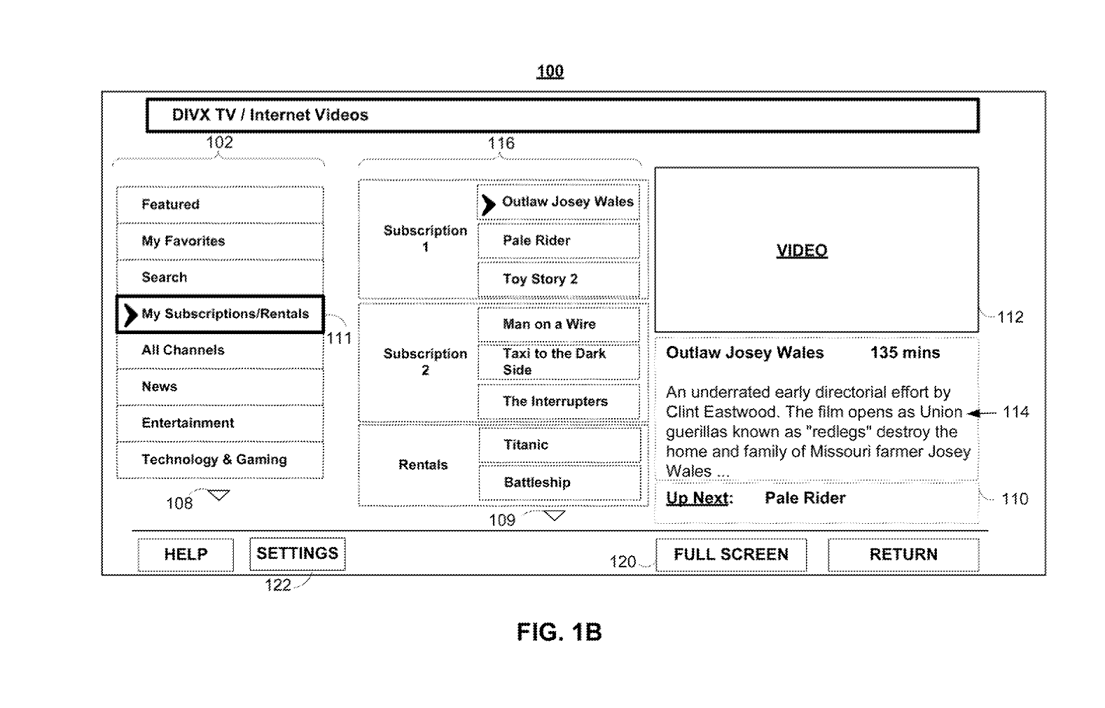

FIGS. 1A and 1B show an example 100 of a guidance display that can be provided as part of an interactive media guidance application in accordance with some embodiments. Display 100 can be used in some embodiments to review information about available media content, to select media content for immediate presentation, to select media content for subsequent presentation, to select media content for recording, to set reminders to regarding media content, and/or to perform any other suitable function.

In some embodiments, a user may be presented with display 100 in response to the user selecting a selectable option provided in a displayed menu (e.g., an “Internet Videos” option, a “DivXTV” option, a “Program Listings” option, etc.), pressing a dedicated button (e.g., a GUIDE button) on a user input interface or device, and/or taking any other suitable action.

As illustrated in FIG. 1A, guidance display 100 may present one or more lists of categories of media identifiers and one or more lists of media identifiers corresponding to a selected list of categories of media identifiers, in some embodiments. For example, as shown in FIG. 1A, display 100 can include a first list of categories of media identifiers 102 and a second list of media identifiers 104 that lists particular pieces of media content within a selected category that are available for presentation. More particularly, for example, as shown, media identifiers in first list of categories of media identifiers 102 can include “Featured,” “My Favorites,” “Search,” “My Subscriptions/Rentals,” “All Channels,” “News,” “Entertainment,” “Technology & Gaming,” and/or any other suitable media identifiers.

In response to a user selecting a category of media identifiers in list 102, a highlight region 106 may be presented around the selected category, in some embodiments. A corresponding set of media identifiers 101 may then be presented in list of media identifiers 104, in some embodiments. Each media identifier may identify one or more pieces of media content available for presentation to the user, in some embodiments. For each media identifier 101, a source identifier 103, an “add” button 105, and a “watch” button 107 may also be presented, in some embodiments. Source identifier 103 may identify any suitable source for the corresponding media content, in some embodiments. For example, the source identifier may indicate that corresponding media content is available from a subscription service, from a rental service, from an over-the-air service, from an Internet service, from a cable provider, etc. “Add” button 105 may be used by the user to request that the corresponding media content be added to a set of one or more pieces of media content available for later presentation, in some embodiments. For example, button 105 may be user to request that a piece of media content, such as the movie “Outlaw Josey Wales” be added to a set of pieces of media content that can be accessed from the “My Subscriptions/Rentals” category in list 102. In this way, a user can build a list of movies that the user plans to watch at one or more future points in time, for example. “Watch” button 107 may be used to cause the media content to be presented immediately if available, in some embodiments.

As shown in FIG. 1B, when “My Subscriptions/Rentals” is highlighted (as shown by highlight region 111), pieces of media content that have been previously added to a set of one or more pieces of media content available for later presentation can be listed in list 104. As illustrated, in list 104, any one or more of these pieces of media content can be indicated as corresponding to a particular provider of media content, such as a subscription provider (e.g., “Subscription 1,” “Subscription 2,” “Rentals,” etc.).

Additional categories of media identifiers and additional media identifiers may be presented in response to a user selecting a navigational icon 108 and a navigation icon 109, respectively, in some embodiments.

Display 100 may also include a media queue region 110 that lists one or more pieces of media content selected and queued for playback, and a video region 112 in which pieces of media content can be presented, in some embodiments.

In some embodiments, information 114 relating to a piece of media content can also be presented to a user. For example, information 114 can include a name of a piece of media content, a time at which the media content is available (if applicable), a source (e.g., channel, Web address, etc.) from which the media content can be obtained, a parental rating for the piece of media content, a duration of the piece of media content, a description of the piece of media content, a review or a quality rating of the piece of media content, and/or any other suitable information.

In some embodiments, pieces of media content can be played in a full sired display screen in response to a user selecting “full screen” button 120.

In some embodiments, a user may be able to set settings related to the interactive media guidance application by pressing a settings button, such as settings button 122 of FIG. 1. The settings that can be set can include any suitable settings such as channel and program favorites, programming preferences that the guidance application can utilize to make programming recommendations, display preferences, language preferences, and/or any other suitable settings.

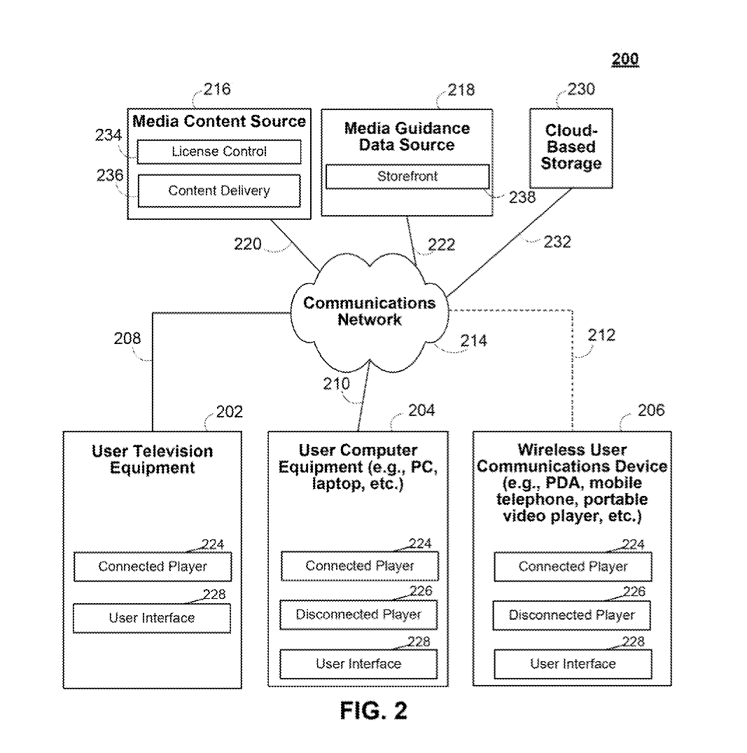

Turning to FIG. 2, an example 200 of an architecture of hardware that can be used in accordance with some embodiments is shown. As illustrated, architecture 200 can include a user television equipment device 202, a user computer equipment device 204, a wireless user communication device 206, a communications network 214, a media content source 216, a media guidance data source 218, cloud-based storage 230, and communication paths 208, 210, 212, 220, 222, and 232, in some embodiments.

In some embodiments, user television equipment device 202, user computer equipment device 204, and wireless user communication device 206, which can each be referred to herein as a “user equipment device,” can be any suitable devices for presenting media content, presenting an interactive media guidance application for selecting content, and/or performing any other suitable functions as described herein.

User television equipment device 202 can be any suitable user television equipment device or devices in some embodiments. For example, in some embodiments, user television equipment device 202 can include any suitable television, smart TV, set-top box, integrated receiver decoder (IRD) for handling satellite television, digital storage device, digital media receiver (DMR), digital media adapter (DMA), streaming media device, DVD player, DVD recorder, connected DVD, local media server, BLU-RAY player, BLU-RAY recorder, any other suitable user television equipment, and/or any other suitable combination of the same.

User computer equipment 204 can be any suitable user computer equipment in some embodiments. For example, in some embodiments, user computer equipment 204 can include any suitable personal computer (PC), laptop computer, tablet computer, WebTV box, personal computer television (PC/TV), PC media server, PC media center, hand-held computer, stationary telephone, non-portable gaming machine, any other suitable user computer equipment, and/or any other suitable combination of the same.

Wireless user communication device 206 can be any suitable wireless user communication device or devices in some embodiments. For example, in some embodiments, wireless user communication device 206 can include any suitable personal digital assistant (PDA), mobile telephone, portable video player, portable music player, portable gaming machine, smart phone, any other suitable wireless device, and/or any suitable combination of the same.

In some embodiments, as shown in FIG. 2, one or more of user equipment devices 202, 204, and 206 can include a connected player process 224, a disconnected player process 226, a user interface process 228, and/or any other suitable additional or alternative processes, functions, etc. Connected player process 224 can be any suitable process for playing media content while process 22A is connected via communication network 214 to a license control process (described below), in some embodiments. Disconnected player process 226 can be any suitable process for playing media content while process 226 is disconnected from a license control process. User interface process 228 can be any suitable process for providing a user interface to a user. For example, user interface process 228 can be a process for presenting a media guidance display, like display 100 of FIGS. 1A and 1B to a user, and for receiving user inputs in response thereto.

In some embodiments, user equipment devices may be connectable to a communications network. For example, in some embodiments, user equipment devices may be Internet-enabled allowing them to access Internet media content.

In some embodiments, communications network 214 may be any one or more networks including the Internet, a mobile phone network, a mobile voice network, a mobile data network (e.g., a 3G, 4G, or LTE network), a cable network, a satellite network, a public switched telephone network, a local area network, a wide area network, any other suitable type of communications network, and/or any suitable combination of communications networks.

Media content source 216 may include one or more types of content distribution equipment for distributing any suitable media content, including television distribution facility equipment, cable system head-end equipment, satellite distribution facility equipment, programming source equipment (e.g., equipment of television broadcasters, such as NBC, ABC, HBO, etc.) intermediate distribution facility equipment, Internet provider equipment, on-demand media server equipment, and/or any other suitable media content provider equipment, in some embodiments. NBC is a trademark owned by the National Broadcasting Company, Inc., ABC is a trademark owned by the American Broadcasting Companies, INC., and HBO is a trademark owned by the Home Box Office, Inc.

Media content source 216 may be operated by the originator of content (e.g., a television broadcaster, a Webcast provider, etc.) or may be operated by a party other than the originator of content (e.g., an on-demand content provider, an Internet provider of content of broadcast programs for downloading, etc.), in some embodiments.

Media content source 216 may be operated by cable providers, satellite providers, on-demand providers, Internet providers, providers of over-the-top content, subscription providers, rental providers, and/or any other suitable provider(s) of content, in some embodiments.

Media content source 216 may include a remote media server used to store different types of content (including video content selected by a user), in a location remote from any of the user equipment devices, in some embodiments. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

As illustrated in FIG. 2, in some embodiments, media content source 216 can include a license control process 234, a content delivery process 236, and/or any other suitable additional or alternative processes, functions, etc. License control process 234 can be any suitable process for controlling licenses to media content and determining under what conditions media content can be accessed, in some embodiments. Content delivery process 236 can be any suitable process for controlling the delivery of media content, in some embodiments.

Media guidance data source 218 may provide any suitable media guidance data, such as names of pieces of media content, times at which the media content is available (if applicable), sources (e.g., channels, Web addresses, etc.) from which the media content can be obtained, parental ratings for the pieces of media content, durations of the pieces of media content, descriptions of the pieces of media content, reviews or quality ratings of the pieces of media content, and/or any other suitable information, in some embodiments.

Media guidance data may be provided by media guidance data source 218 to the user equipment devices using any suitable approach, in some embodiments. In some embodiments, for example, an interactive media guidance application may be a stand-alone interactive television program guide that receives this media guidance data from media guidance data source 218 via a data feed (e.g., a continuous feed or trickle feed). In some embodiments, this media guidance data may be provided to the user equipment on a television channel sideband, using an in-band digital signal, using an out-of-band digital signal, or by any other suitable data transmission technique from media guidance data source 218. In some embodiments, this media guidance data may be provided to user equipment on multiple analog or digital television channels from media guidance data source 218. In some embodiments, media guidance data from media guidance data source 218 may be provided to users' equipment using a client-server approach, wherein media guidance data source 218 acts as a server.

As illustrated in FIG. 2, in some embodiments, media guidance data source 218 can include a storefront process 238 and/or any other suitable additional or alternative processes, functions, etc. In some embodiments, storefront process 238 can be any suitable process for enabling a user to access subscription-based and/or rental-based media content such as by receiving a user's selection to access a piece of media content as part of a subscription and/or a user's selection to access a piece of media content by renting the content. A storefront process may, for example, control the presentation of subscription and/or rental options in a media guidance display 100 as illustrated in FIGS. 1A and 1B, in some embodiments.

Cloud-based storage 230 can be any suitable storage for storing any suitable content, data, licenses, etc. so that it is accessible via communication network 214, in some embodiments. In some embodiments, cloud-based storage 230 can be virtualized pools of storage hosted in an Internet data center, such as the Amazon S3 storage provided by Amazon Web Services of Herndon, Va., USA. In some embodiments, cloud-based storage 230 can be used to “locally” cache media content for presentation on user equipment devices 202, 204, and/or 206 rather than store that content in user equipment devices 202, 204, and/or 206.

Although only one each of user equipment, devices 202, 204, and/or 206, sources 216 and 218, and storage 230 are illustrated in FIG. 2 in order to avoid over complicating the drawing, any suitable number of each of these components can be provided in some embodiments. For example, although only one media content source 216 is shown in FIG. 2, in some embodiments, at least two media content sources 216 can be provided, a license control process 234 can be performed in one of the sources, a content delivery process 236 can be performed in another of these sources, and processes 234 and 236 can communicate in any suitable manner.

Each user may utilize more than one type of user equipment device in some embodiments. In some embodiments, any of user equipment devices 202, 204, and 206 can be combined, and any of sources 216 and 218 can be combined.

Paths 208, 210, 212, 220, 222, and 232 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths, in some embodiments. Path 212 is drawn with dotted lines to indicate that, in the exemplary embodiment shown in FIG. 2, it can be a wireless path (although this path may be a wired path, if desired), and paths 208, 210, 220, 222, and 232 are drawn as solid lines to indicate they can be wired paths (although these paths may be wireless paths, if desired). In some embodiments, communication to/from user equipment devices 202, 204, and 206, sources 216 and 218, and storage 230 may be provided by one or more of communications paths 208, 210, 212, 220, 222, and 232, respectively, but are shown as a single path in FIG. 2 to avoid overcomplicating the drawing.

Although communications paths are not drawn between user equipment devices 202, 204, and 206, sources 216 and 218, and storage 230, these components may communicate directly with each other via communication paths, such as those described above, as well via point-to-point communication paths, such as USE cables, IEEE 1394 cables, wireless paths (e.g., Bluetooth, infrared, IEEE 802.11x, etc.), or other communication via wired or wireless paths, in some embodiments. BLUETOOTH is a certification mark owned by Bluetooth SIG, INC. The user equipment devices 202, 204, and 206, sources 216 and 218, and storage 230 may also communicate with each other directly through an indirect path via communications network 214, in some embodiments.

In some embodiments, sources 216 and 218 and storage 230 can be implemented in any suitable hardware. For example, sources 216 and 218 and storage 230 can be implemented in any of a general purpose device such as a computer or a special purpose device such as a client, a server, mobile terminal (e.g., mobile phone), etc. Any of these general or special purpose devices can include any suitable components such as a hardware processor (which can be a microprocessor, digital signal processor, a controller, etc.) (or processing circuitry, such as processing circuitry 306 described below), memory (or storage, such as storage 308 described below), communication interfaces, display controllers, input devices, etc. A combination of such a hardware processor (which can be a microprocessor, digital signal processor, a controller, etc.) (or processing circuitry, such as processing circuitry 306 described below) and memory (or storage, such as storage 308 described below) can be referred to herein as control circuitry.

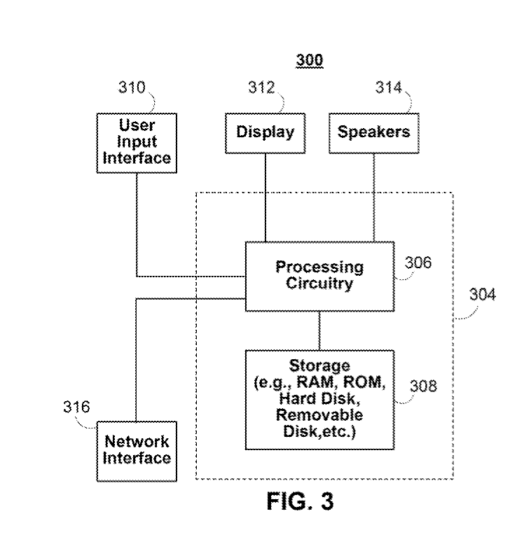

FIG. 3 shows an example of hardware that can be provided in an illustrative user equipment device 300, such as user television equipment device 202, user computer equipment device 204, and/or wireless user communication device 206 of FIG. 2, in accordance with some embodiments. As illustrated, device 300 can include control circuitry 304 (which can include processing circuitry 306 and storage 303), a user input interface 310, a display 312, speakers 314, and an input/output (hereinafter “I/O”) interface 316, in some embodiments.

Control circuitry 304 may include any suitable processing circuitry such as processing circuitry 306. As referred to herein, processing circuitry 306 can be circuitry that includes one or more microprocessors, microcontrollers, digital signal processors, programmable logic devices, field-programmable gate arrays (FPGAs), application-specific integrated circuits (ASICs), hardware processors, etc., and may include a multi-core processor (e.g., dual-core, quad-core, hexa-core, or any suitable number of cores) or a supercomputer, in some embodiments. In some embodiments, processing circuitry may be distributed across multiple separate processors or processing units, such as, for example, multiple of the same type of processing units (e.g., two Intel Core i7 processors) or multiple different processors (e.g., an Intel Core i5 processor and an Intel Core i7 processor).

Storage 308 can be any suitable digital storage mechanism in some embodiments. For example, storage 303 can include any device for storing electronic data, program instructions, computer software, firmware, register values, etc., such as random-access memory, read-only memory, hard drives, optical drives, digital video disc (DVD) recorders, compact disc (CD) recorders, BLU-RAY disc (BD) recorders, BLD-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store media content, media guidance data, executable instructions (e.g., programs, software, scripts, etc.) for providing an interactive media guidance application, and for any other suitable functions, and/or any other suitable data or program code, in accordance with some embodiments. Nonvolatile memory may also be used (e.g., to launch a boot-up routine and other instructions), in some embodiments. Cloud-based storage may be used to supplement storage 308 or instead of storage 308 in some embodiments.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits, in some embodiments, Encoding circuitry (e.g., for converting over-the-air, analog, or digital signals to MPEG signals for storage) may also be provided, in some embodiments. Control circuitry 304 may also include scaler circuitry for upconverting and downconverting content into the preferred output format of the user equipment 300, in some embodiments. Circuitry 304 may also include digital-to-analog converter circuitry and analog-to-digital converter circuitry for converting between digital and analog signals. The video generating circuitry may be used for presenting media content, in some embodiments. The tuning and encoding circuitry may be used by the user equipment device to receive and to display, to play, or to record content, in some embodiments. The tuning and encoding circuitry may also be used to receive guidance data, in some embodiments. The circuitry described herein, including for example, the tuning, video generating, encoding, decoding, encrypting, decrypting, scaler, and analog/digital circuitry, may be implemented using software rears leg on one or more general purpose or special purpose hardware processors, in some embodiments. Multiple tuners may be provided to handle simultaneous tuning functions (e.g., watch and record functions, picture-in-picture (PIP) functions, multiple-tuner recording, etc.), in some embodiments. If storage 308 is provided as a separate device from user equipment 300, the tuning and encoding circuitry (including multiple tuners) may be associated with storage 308, in some embodiments.

A user may send instructions to control circuitry 304 using user input interface 310, in some embodiments. User input interface 310 may be any suitable user interface, such as a remote control, mouse, trackball, keypad, keyboard, touch screen, touchpad, stylus input, joystick, voice recognition interface, or other user input interfaces, in some embodiments.

Display 312 may be provided as a stand-alone device or integrated with other elements of user equipment device 300, in some embodiments. Display 312 may be one or more of a monitor, a television, a liquid crystal display (LCD) for a mobile device, or any other suitable equipment for displaying visual images, in some embodiments. In some embodiments, display 312 may be HDTV-capable. In some embodiments, display 312 may be a 3D display.

A video card or graphics card may generate the output to display 312, in some embodiments. The video card may offer various functions such as accelerated rendering of 3D scenes and 2D graphics, MPEG-2/MPEG-4 decoding, TV output, or the ability to connect multiple monitors, in some embodiments. The video card may be any processing circuitry described above in relation to control circuitry 304, in some embodiments. The video card may be integrated with the control circuitry 304 or may be integrated with display 312, in some embodiments.

Speakers 314 may be provided as integrated with other elements of user equipment device 300 or may be stand-alone units, in some embodiments. The audio component of media content displayed on display 312 may be played through speakers 314, in some embodiments. In some embodiments, the audio may be distributed to a receiver (not shown), which processes and outputs the audio via speakers 314.

I/O interface 316 can be any suitable I/O interface 316 in some embodiments. For example, in some embodiments, I/O interface 316 can be any suitable interface for coupling control circuitry 304 (and specifically processing circuitry 306) to one or more communications paths (e.g., paths 208, 210, and 212 described in FIG. 2). More particularly, for example, I/O interface 316 can include a cable modem, an integrated services digital network (ISDN) modem, a digital subscriber line (DSL) modem, a telephone modem, an Ethernet card, a fiber-optic modem, a wireless modem, and/or any other suitable communications circuitry. In some embodiments, the I/O interface can be used to provide content and data from an external location to device 300. For example, in some embodiments, I/O interface 316 can be used to provide media content (e.g., broadcast programming, on-demand programming, Internet content, content available over a local area network (LAN) or wide area network (WAN), and/or any other suitable content), media guidance data, subtitles, time codes, and/or any other suitable information or data to control circuitry 304 of device 300. In some embodiments, I/O interface 316 can also be used to send and receive commands, requests, and other suitable data from and to, respectively, control circuitry 304. Any suitable number of I/O interfaces 316 can be provided, even though only one is shown in FIG. 3 to avoid overcomplicating the drawing.

The processes for playing back media content, the interactive media guidance application and/or any other suitable functions as described herein may be implemented as stand-alone applications on user equipment devices in some embodiments. For example, the processes for playing back media content and/or the interactive media guidance application may be implemented as software or a set of executable instructions which may be stored in storage 308, and executed by control circuitry 304 of a user equipment device 300.

In some embodiments, the processes for playing back media content, the interactive media guidance application, and/or any other suitable functions as described herein may be implemented as client-server applications. In such client-server applications, a client application may reside on a user equipment device, and a server application may reside on a remote server, such as source 216. For example, the processes for playing back media content may be implemented partially as a client application on control circuitry 304 of user equipment device 300 and partially as a server application on media content source 216. As another example, an interactive media guidance application may be implemented partially as a client application on control circuitry 304 of user equipment device 300 and partially on a remote server (e.g., media guidance data source 218 of FIG. 2) as a server application running on control circuitry of the remote server.

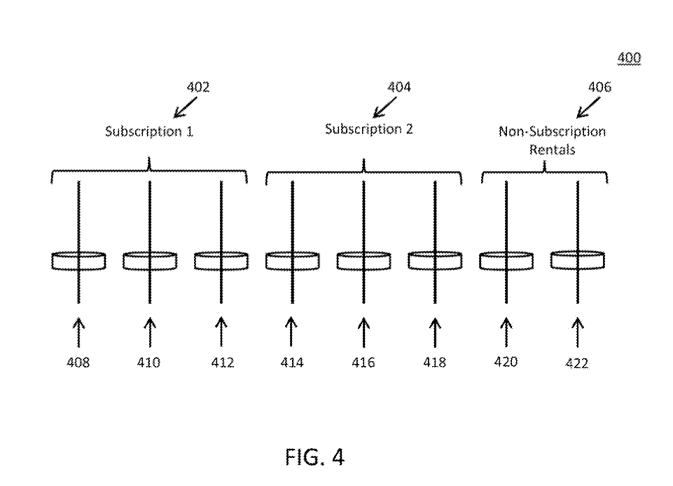

FIG. 4 illustrates an example 400 of a graphical illustration of a first architecture for controlling access to media content in accordance with some embodiments of the invention. In this architecture, media content can be controlled in groups of one or more pieces of content, which can be referred to as slots. For example, as shown in FIG, 4, each slot can be illustrated as a vertical line with one or more discs shown centered on the vertical line. In FIG. 4, eight slots 408, 410, 412, 414, 416, 418, 420, and 422 are shown, although any suitable number of slots can be used in some embodiments.

Sets of one or more slots can have one or more common characteristic, in some embodiments. For example, as shown, slots 408, 410, and 412 in a set 402 can have the common characteristic of being associated with “subscription 1,” slots 414, 416, and 416 in a set 404 can have the common characteristic of being associated with “subscription 2,” and slots 420 and 422 in a set 406 can have the common characteristic of being “non-subscription rentals.”

As content is made available, the content can be associated with a slot or a set of slots. This association can be made in any suitable manner. For example, as a new piece of media content is made available, the new content can be associated with slot 408. When a next new piece of content is made available, the new piece of content can be associated with slot 410. Upon another new piece of content being made available, the new content can be associated with slot 412. In order for yet another new piece of content to be associated with the “subscription 1” 402 set of slots, an “old” piece of content needs to be disassociated from one of slots 403, 410, and 412 of the set. For example, old content can be disassociated from slot 408 so that new content can then be associated with slot 408.

Content can be made available in any suitable manner. For example, content can be made by a user selecting the content from a media guidance display and selecting to add the content to a subscription (e.g., such as subscription 1 402).

Content can be disassociated in any suitable manner. For example, content can be disassociated with a slot or a set of one or more slots after a certain period of time (e.g., one month, 24 hours, etc.), after a certain number of views of the content, upon the occurrence of an event (such as the content being released in a certain manner), upon the expiration of a subscription, in response to a manual selection by a user, upon a user playing some new piece of content to be associated with a corresponding slot, etc. Whether content is disassociated with a slot or a set of one or more slots can be controlled in any suitable manner. For example, in some embodiments, under certain conditions, a user equipment device can determine that content is to be disassociated with a slot or set of slots. As another example, in some embodiments, under certain conditions, a remote device (e.g., such as a media content source, a media guidance source, etc.) can determine that content on a user equipment device is to be disassociated with a slot or set of slots.

While a piece of content is associated with the set, the accessibility of the content may be limited in any suitable manner. For example, content that is associated with slots 408, 410, or 412 may be presentable only a suitable limited number of times, or may be presentable an unlimited number of times, in some embodiments. When a piece of content is presentable only a limited number of times and the content has been presented that limited number of times, the content may be automatically disassociated with the slots and/or group of slots in some embodiments.

A similar process can be used for “subscription 2” set 404 of slots 414, 416, and 418 as new content is associated with the set, as old content is disassociated from the set, and as content associated with the set is accessed. “Subscription 2” set 404 can be associated with a different subscription service than “Subscription 1” set 402 in some embodiments.

Likewise, a similar process can be used for “non-subscription rentals” set 406 of slots 420 and 422 as new content is associated with the set, as old content is disassociated from the set, and as content associated with the set is accessed. In some embodiments, the accessibility of media content associated with “non-subscription rentals” set 406 may be limited in a manner that is different from “Subscription 1” set 402 and/or “Subscription 2” set 404. For example, content that is associated with slots 420 and 422 may be presentable only a suitable limited number of times while content that is associated with slots 408, 410, or 412 may be presentable an unlimited number of times, in some embodiments.

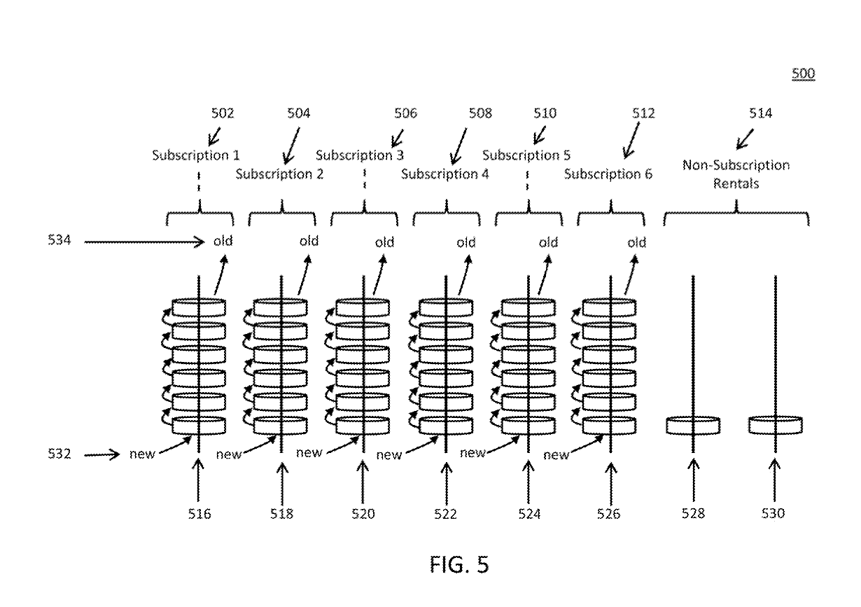

Turning to FIG. 5, an example 500 of a graphical illustration of a second architecture for controlling access to media content in accordance with some embodiments of the invention is shown. As illustrated, like in example 400 of FIG. 4, the architecture of example 500 can be based on any suitable number of slots, in some embodiments. For example, as shown, this architecture can include eight slots 516, 518, 520, 522, 524, 526, 528, and 530. Also, like in example 400, the architecture can include any suitable number of sets of one or more slots, in some embodiments. For example, as shown, this architecture can include sets 502, 504, 506, 508, 510, 512, and 514, where each of sets 502, 504, 506, 508, 510, and 512 is associated with a subscription and set 514 is associated with non-subscription rentals.

Unlike what is shown in example 400 of FIG. 4, at least some of the slots shown (e.g., slots 516, 518, 520, 522, 524, and 526) can include the ability to associate multiple pieces of media content with a given slot, in some embodiments. Any suitable number of pieces of media content can be associated with a slot in some embodiments. For example, as shown, six pieces of media content can be associated with a slot.

In some embodiments, when a new piece of content 532 becomes available, the new piece of content can be associated with a slot (e.g., slot 516). As new pieces of content become available and associated with the same slot, older pieces of content 534 can be removed disassociated with the slot. The number of pieces of content that can be associated with a slot can be limited in any suitable manner. For example, in some embodiments, only a limited number of pieces of content (e.g., six) can be associated with a slot during a given period of time (e.g., one month). As another example, no more than a fixed number (e.g., six) of pieces of content can be associated with a given slot at any given point in time. Any suitable device can control limitations on the association of content with one or more slots. For example, in some embodiments, a user equipment device can control such limitations. As another example, in some embodiments, a remote device (e.g., such as a media content source, a media guidance source, etc.) can control such limitations.

“Son-subscription rentals” set 514 of slots 528 and 530 can behave similarly to “non-subscription rentals” set 406 of slots 420 and 422 shown in and described in connection with FIG. 4 in some embodiments.

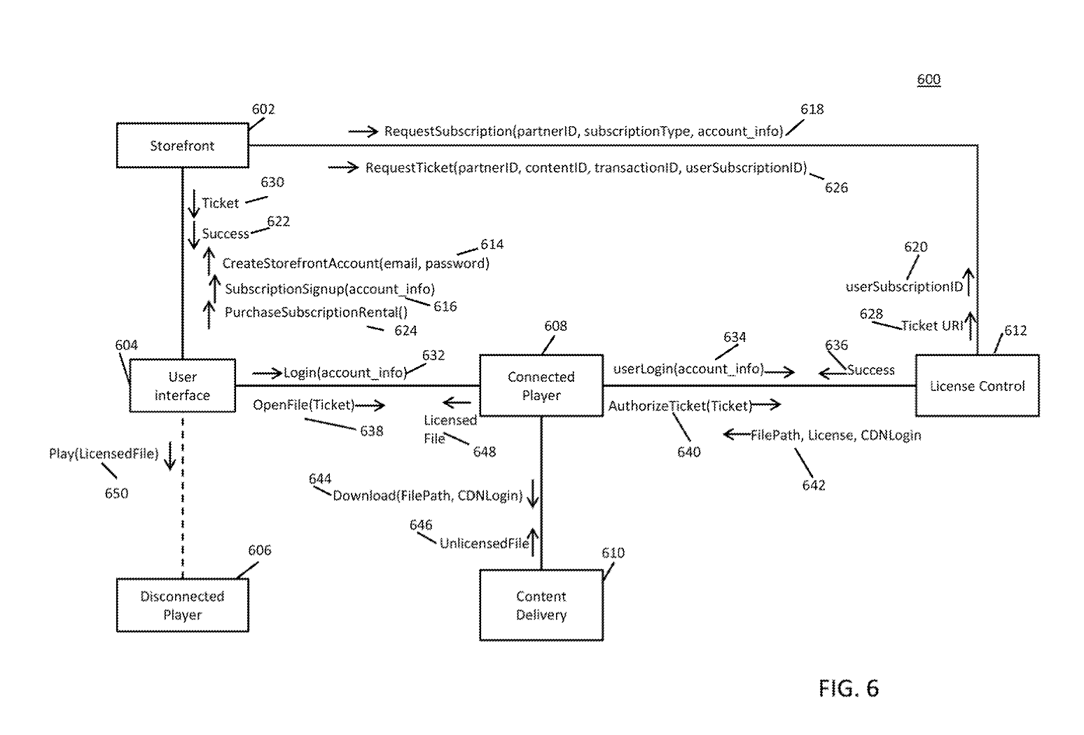

FIG. 6 illustrates an example 600 of a process for setting-up a subscription and accessing media content under a subscription, in accordance with some embodiments.

As shown, process 600 can send a series of messages between a storefront process 602, a user interface 604, a disconnected player process 606, a connected player process 608, a content delivery process 610, a license control process 612, and/or any other suitable process(es), functions), hardware, and/or software.

Storefront process 602, like storefront process 238, can be any suitable process for enabling a user to access subscription-based and/or rental-based, media content such as by receiving a user's selection to access a piece of media content as part of a subscription and/or a user's selection to access a piece of media content by renting the content, in some embodiments. A storefront process may, for example, control the presentation of subscription and/or rental options in a media guidance display 100 as illustrated in FIGS. 1A and 1B. Storefront process 602 can be stored as executable instructions in storage of media guidance data source 218 and executed at least in part in control circuitry of the media guidance data source, in some embodiments.

User interface process 604 can be any suitable process for providing a user interface to a user, in some embodiments. For example, user interface process 604, like user interface process 226, can be a process for presenting a media guidance display, like display 100 of FIGS. 1A and 1B to a user, and for receiving user inputs in response thereto. User interface process 604 can be stored as executable instructions in storage of a user equipment device and executed at least in part in control circuitry of the user equipment device, in some embodiments.

Disconnected player process 606, like disconnected player process 226, can be any suitable process for playing media content while process 606 is disconnected from license control process 612, content delivery process 610, and connected player 608, in some embodiments. Disconnected player process 606 can be stored as executable instructions in storage of a user equipment device and executed at least in part in control circuitry of the user equipment device, in some embodiments.

Connected player process 608, like connected player process 224, can be any suitable process for playing media content while process 608 is connected via communication network 214 to license control process 612, content delivery process 610, and connected player 608, in some embodiments. Connected player process 608 can be stored as executable instructions in storage of a user equipment device and executed at least in part in control circuitry of the user equipment device, in some embodiments.

Content delivery process 610, like content delivery process 236, can be any suitable process for controlling the delivery of media content, in some embodiments. Content delivery process 610 can be stored as executable instructions in storage of media content source 216 and executed at least in part in control circuitry of the media content source, in some embodiments.

License control process 612, like license control process 234, can be any suitable process for controlling licenses to media content and determining under what conditions media content can be accessed, in some embodiments. License control process 612 can be stored as executable instructions in storage of media content source 216 and executed at least in part in control circuitry of the media content source, in some embodiments.

In some embodiments, before a user can select media content to be viewed under a subscription or as a rental, the user may be required to have an a storefront account and a subscription. In order to establish a storefront account, in some embodiments, a user can first use user interface 604 to enter an email address and a password, and then user interface 604 can send a create-a-storefront-account message 614 to storefront process 604. Message 614 can include the entered email address, the entered password, and/or any other suitable information and/or data, in some embodiments.

In order to establish a subscription, user interface 604 can send a subscription-sign-up message 616 to storefront 602, in some embodiments. Message 616 can include any suitable account information, and/or any other suitable information and/or data, in some embodiments. In response to message 616, the storefront process can send a request-for-subscription message 618 to license control process 612, in some embodiments. Message 610 can include a partner identifier, a subscription type, account information, arid/or any other suitable information and/or data, in some embodiments. In some embodiments, the storefront process may be required to contact the license control process prior to enlisting a user in a subscription in order to ensure that adequate subscription slots are available on user equipment devices assigned to the user. Once a subscription has been established by the license control process, a user-subscription-identifier message 620 can then be sent from license control process 612 to storefront process 602, in some embodiments. In response to receiving message 620, storefront process 602 can send a success message 622 to user interface 604 to indicate that a subscription was issued, in some embodiments.

Once a subscription has been establish, a user can access media content that is part of that subscription, in some embodiments. In response to the user indicating that the user wants to access media content under the subscription, user interface 604 can send a purchase-subscription-rental message 624 specifying the media content to be rented to the storefront 602, in some embodiments.

In response to receiving message 624, the storefront process can determine whether the user has reached any limits on the availability of media under the subscription, in some embodiments. For example, if the user has reached a limit on the number of pieces of media content (e.g., six) that are accessible for the current time period (e.g., one month), the storefront process can determine that the user cannot access the media content.

If it is determined that user is not prevented from accessing the media content, storefront process 602 can then send a request-ticket message 626 to license control process 612, in some embodiments. Message 626 can include a partner identifier, a content identifier, a transaction identifier, a user subscription identifier, and/or any other suitable information and/or data, in some embodiments.

A ticket uniform-resource-indicator message 628 can then be sent from license control process 612 to storefront process 602, in some embodiments. Because tickets can be tied to a specific subscription in some embodiments, the ticket may be required to be assigned to a particular user (e.g. a pre-torn ticket, which can specify a user identifier of the user for whom the ticket is pre-torn) rather than being interchangeable between all users in some embodiments.

In response to receiving message 628, storefront process 602 can then send a ticket 630 to user interface 604 to enable the user to access the desired media content, in some embodiments.

When a user wants to be presented with the media content, the user can first log-in in some embodiments. In some embodiments, a user does not need to take any action to log-in, such as when the user is attempting to access the media content from a home device.

In response to the user logging-in or when the user does not need to take any action to log-in, user interface 604 can send a login message 632 to connected player 608, in some embodiments. Message 632 can include the user's account information and/or any other suitable information and/or data, in some embodiments. A user login message 634 containing the user's account information can then be sent from connected player 608 to license control process 612, in some embodiments. If the account information is valid, a success message 636 can then be sent from license control process 612 to connected player 608, in some embodiments.

After successfully logging-in, an open file message 638, which can include ticket 630, can also be sent from user interface 604 to connected player 608 to access the desired media content, in some embodiments. In response to receiving message 638, connected player process 608 can send an authorize ticket message 640, which can include ticket 630, to license control 612, in some embodiments.

Next, a message 642, indicating a file path, a license, content delivery network login information, and/or any other suitable information and/or data, can then be provided from license control process 612 to connected player process 608, in some embodiments,

In some embodiments, license control process 612 can select a specific slot to which the media content will be associated at the time of content licensing by the player, in some embodiments. This selection can be based on details of the subscription under which the media content is licenses, in some embodiments.

In response to receiving message 642, connected player process 608 can then send a download message 644 to content delivery process 610, in some embodiments. Message 644 can include the file path, the content delivery network login information, and/or any other suitable information and/or data, in some embodiments. An unlicensed file 646 can then be provided by content delivery process 610 to connected player process 608, in some embodiments.

Upon receiving file 646, connected player process 608 can then apply the license received with message 642 to the unlicensed file and provide a licensed file 648 to user interface 604, in some embodiments.

Finally, in some embodiments, a user can access user interface 604 to transfer licensed file 648 as part of a play package 650 to disconnected player 606. As represented by the dashed line between 604 and 606, this transfer can happen manually in some embodiments—e.g., via a thumb drive, etc. Once the play package 650 is on the disconnected player, the user can cause the disconnected player to play the media content.

It should be understood that the above steps of the flow diagram of FIG. 6 may be executed or performed in any order or sequence not limited to the order and sequence shown and described in the figure. Also, some of the above steps of the flow diagram of FIG. 6 may be executed or performed substantially simultaneously where appropriate or in parallel to reduce latency and processing times.

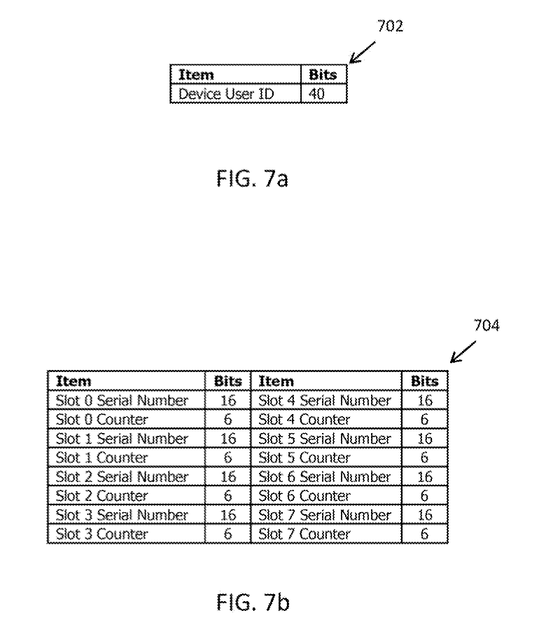

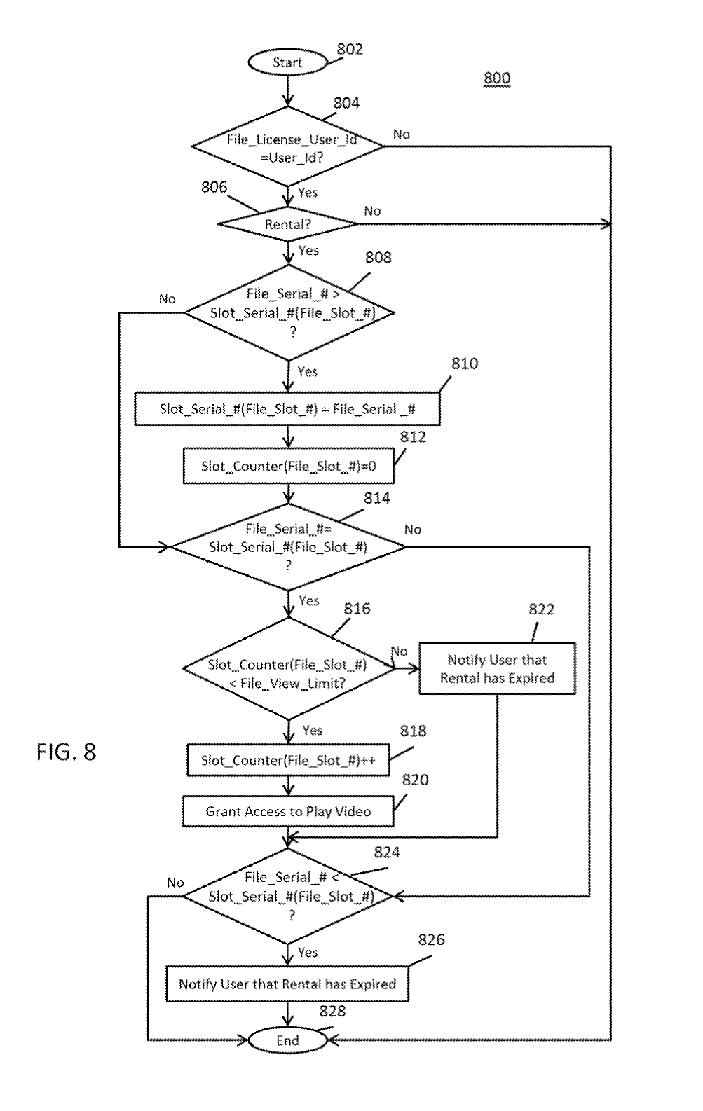

FIGS. 7a and 7b illustrate examples of data structures for storing data relating the control of access to media content that can be used in accordance with some embodiments.

As shown in FIG. 7a, data structure 702 can be used to store a device user identifier in accordance with some embodiments. Any suitable device user identifier can be stored in data structure 702, the device user identifier can have any suitable length (such as 40 bits as shown), and data structure 702 can be stored in any suitable portion of storage 309 of a user equipment device (FIG. 3).

FIG. 7b illustrates a data structure 704 that can be used to store serial numbers and counters for slots in accordance with some embodiments. Any suitable serial numbers and counters can be stored in data structure 704, such serial numbers and counters can be for any suitable slots (such as slots 0-7), the serial numbers and counters can have any suitable lengths (such as 16 and 6 bits, respectively, as shown), and data structure 704 can be stored in any suitable portion of storage 309 of a user equipment device (FIG. 3).

FIG. 8 illustrates an example 800 of a process for controlling access to media content in accordance with some embodiments.

As shown, after process 800 begins at 802, the process checks that a file for given media content is licensed for the same user that the device is registered to at 804. This check can be performed in any suitable manner. For example, this check can compare the file's license user identifier to a device user identifier as stored in a data structure 702 as shown in FIG. 7a. If the file for the given media content is not licensed for the same user that the device is registered to, process can terminate at 828. Otherwise, process 800 can continue on to 806.

At 806, process 800 can check the license type to determine if it is of the proper type. For example, as illustrated, process 800 can determine if the license type is a rental license type (or any other suitable type). This determination can be made in any suitable manner. If the license type is determined to not be the proper type, process 800 can terminate at 828. Otherwise, process 800 can continue to 608.

At 808, process 800 can check if the file serial number is greater than the serial number in the slot that the file indicates it belongs in. This check can be made in any suitable manner. For example, this check can be made by comparing the file serial number to the number stored in the corresponding slot serial number location of data structure 704 of FIG. 7b. If the file serial number is not greater than the serial number in the slot that the file indicates it belongs in, process 800 can branch to 814, described below. Otherwise, process 800 can continue to 810.

At 810, process 800 can write the file serial number to the slot and expire the old media content that previously occupied the slot. Writing the file serial number to the slot and expiring the old media content that previously occupied the slot can be performed in any suitable manner. For example, in some embodiments, this can be performed by writing the file serial number to the corresponding slot serial number location in data structure 704 of FIG. 7b.

At 812, process 800 can clear the slot counter to zero. This can be performed in any suitable manner. For example, in some embodiments, this can be performed by setting the counter for the corresponding slot in data structure 704 of FIG. 7b to zero.

At 814, process 800 can check if the file serial number is the same serial number as the one that is currently in the slot that the file indicates it belongs in. This check can be made in any suitable manner. For example, this check can be made by comparing the file serial number to the number stored in the corresponding slot serial number location of data structure 704 of FIG. 7b. If the file serial number is not equal to the serial number in the slot that the file indicates it belongs in, process 800 can branch to 824, described below. Otherwise, process 800 can continue to 816.

At 816, process 800 can check to see if the view counter is less than the file view limit. This check can be made in any suitable manner. For example, this check can be made by process 800 comparing the file view limit to the value in the corresponding slot counter of data structure 704 of FIG. 7b. At 816, process 800 can also check to see if the file is an unlimited view file. This determination can be made in any suitable manner. For example, in some embodiments, this determination can be made by determining if the file view limit has a special value (e.g., such as a negative value).

If it is determined at 816 that the view counter is less than the file view limit, or that the file is an unlimited view file, then the slot counter (e.g., the counter in data structure 704 of FIG. 7b) can be incremented at 818 and playback access granted at 820. Playback access can be granted at 820 in any suitable manner. For example, in some embodiments, playback access can be granted by creating a license file for the media content by, for example, adding a license header to an unlicensed file for the media content.

Otherwise, if it is determined at 816 that the view counter is not less than the file view limit, and that the file is not an unlimited view file, then process 800 can notify the user that the rental has expired at 822.

After 820 or 822, process 800 can check that the file serial number is less than the serial number in the slot that the file indicates it belongs in at 824. This check can be made in any suitable manner. For example, this check can be made by comparing the file serial number to the number stored in the corresponding slot serial number location of data structure 704 of FIG. 7b. If the file serial number is not less than the serial number in the slot that the file indicates it belongs in, process 800 can terminate at 828. Otherwise, process 800 can notify the user that the rental has expired.

Using a process such as process 800 can provide the ability to configure licenses in many different ways. For example, in some embodiments, such a process can enable all content downloaded within a given month (or any other time period) to be given the same serial number and associated with the same slot. Then, upon the arrival of the following month (or any other following time period), that content can be expired when the serial number is incremented for the next set of movie rentals. As another example, slots 0, 1, and 2 can be reserved for a given content provider, and a limit of three active rental titles (or any other suitable number active rental titles) can be allowed to play at a given time. If the user rents a forth (or an additional rental title), that action can expire one of the current three rental titles that occupy slots 0, 1, and 2.

It should be understood that the above steps of the flow diagram of FIG. 8 may be executed or performed in any order or sequence not limited to the order and sequence shown and described in the figure. Also, some of the above steps of the flow diagram of FIG. 8 may be executed or performed substantially simultaneously where appropriate or in parallel to reduce latency and processing times.

In some embodiments, any suitable computer readable media can be used for storing instructions for performing the mechanisms and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, ate), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

What is claimed is:

1. A system for controlling access to media content, the system comprising:
processing circuitry configured to:
determine whether media content can be associated with a slot;
associate the media content with the slot and resetting a counter for the slot when it is determined that the media content can be associated with the slot;
determine whether the media content is associated with the slot;
grant access to the media content and updating a count of accesses to the media content when it is determined that media content is associated with the slot; and
determine if access to the media content has expired;
prevent access to the media content when it is determined that the access to the media content has expired.

2. The system of claim 1, wherein the slot is represented by at least part of a data structure.

3. The system of claim 1, wherein the processing circuitry is configured to reset the counter by at least setting the counter to zero.

4. The system of claim 1, wherein the processing circuitry is configured to update a count of accesses to the media content by at least incrementing a counter for the slot associated with the media content.

5. The system of claim 1, wherein the processing circuitry is configured to grant access to the media content by at least playing the media content.

6. The system of claim 1, wherein the processing circuitry is configured to determine that access to the media content has expired when the count of accesses has reached or exceeded a threshold.

7. The system of claim 1, wherein the processing circuitry is also configured to determine whether the media content is configured for unlimited access.

8. The system of claim 1, wherein the processing circuitry is also configured to determining that access to the media content has expired by at least determining that the media content has been associated with the slot for a given period of time.

9. A method for controlling access to media content, the method comprising:
determining whether media content can be associated with a slot;
associating, by a processing circuitry, the media content with the slot and resetting a counter for the slot when it is determined that the media content can be associated with the slot;
determining whether the media content is associated with the slot;
granting access to the media content and updating a count of accesses to the media content when it is determined that media content is associated with the slot;
determining if access to the media content has expired; and
preventing access to the media content when it is determined that the access to the media content has expired.

10. The method of claim 9, wherein the slot is represented by at least part of a data structure.

11. The method of claim 9, further comprising resetting the counter by at least setting the counter to zero.

12. The method of claim 9, further comprising updating a count of accesses to the media content by at least incrementing a counter for the slot associated with the media content.

13. The method of claim 9, further comprising granting access to the media content by at least playing the media content.

14. The method of claim 9, further comprising determining that access to the media content has expired when the count of accesses has reached or exceeded a threshold.

15. The method of claim 9, further comprising determining whether the media content is configured for unlimited access.

16. The method of claim 9, further comprising determining that access to the media content has expired by at least determining that the media content has been associated with the slot for a given period of time.

17. A non-transitory computer-readable medium containing computer-executable instructions that, when executed by a processing circuitry, cause the processing circuitry to perform a method for controlling access to media content, the method comprising:
determining whether media content can be associated with a slot;
associating the media content with the slot and resetting a counter for the slot when it is determined that the media content can be associated with the slot;
determining whether the media content is associated with the slot;
granting access to the media content and updating a count of accesses to the media content when it is determined that media content is associated with the slot;
determining if access to the media content has expired; and
preventing access to the media content when it is determined that the access to the media content has expired.

18. The non-transitory computer-readable medium of claim 17, wherein the slot is represented by at least part of a data structure.

19. The non-transitory computer-readable medium of claim 17, wherein the method further comprises resetting the counter by at least setting the counter to zero.

20. The non-transitory computer-readable medium of claim 17, wherein the method further comprises updating a count of accesses to the media content by at least incrementing a counter for the slot associated with the media content.

21. The non-transitory computer-readable medium of claim 17, wherein the method further comprises granting access to the media content by at least playing the media content.

22. The non-transitory computer-readable medium of claim 17, wherein the method further comprises determining that access to the media content has expired when the count of accesses has reached or exceeded a threshold.

23. The non-transitory computer-readable medium of claim 17, wherein the method further comprises determining whether the media content is configured for unlimited access.

24. The non-transitory computer-readable medium of claim 17, wherein the method further comprises determining that access to the media content has expired by at least determining that the media content has been associated with the slot for a given period of time.
